(19) United States
(12) Patent Application Publication
(10) Pub. No.: US 2023/0292810 A1
(43) Pub. Date: Sep. 21, 2023

(54) METHODS AND EQUIPMENT FOR MAKING IRREGULAR-SHAPED EGG PRODUCTS

(71) Applicant: Cargill, Incorporated, Wayzata, MN (US)

(72) Inventors: Noah Robert Klamm, Monticello, MN (US); Paraluman Guillermo, Fairfield, IA (US)

(73) Assignee: Cargill, Incorporated, Wayzata, MN (US)

(21) Appl. No.: 18/041,463

(22) PCT Filed: Jul. 16, 2021
(86) PCT No.: PCT/US2021/041978

§ 371 Date: Feb. 13, 2023

Related U.S. Application Data
(60) Provisional application No. 63/065,050, filed on Aug. 13, 2020.

(51) Int. Cl. A23P 30/10; A23L 15/00; A23L 5/10

(52) U.S. Cl. CPC A23P 30/10; A23L 15/00; A23L 5/10

(57) ABSTRACT

A method of producing individual cooked egg products including the steps of: providing a pan to a liquid egg station, wherein the pan comprises at least one pocket with a bottom wall from which a perimeter side wall extends generally upwardly and inwardly, and the bottom wall comprises a planar portion from which a depressed portion downwardly extends; depositing a volume of a liquid egg product into at least one of the pockets at the liquid egg station; cooking the deposited volume of liquid egg product with a combination of heat and moisture at a cooking station; and removing the cooked egg product from each of the pockets.

### TECHNICAL FIELD

The present invention generally relates to food processing, and more specifically relates to the mass production of cooked egg products that have the appearance of a home-cooked egg patty.

### BACKGROUND

Pre-cooked egg products are used in a number of convenience foods, such as those that are available to consumers in a ready-to-eat format (e.g., a breakfast sandwich from a fast food restaurant or convenience store that includes an egg patty) or in a format in which the consumer prepares the food product for consumption in their home or workplace (e.g., a microwaveable frozen breakfast sandwich that includes an egg patty). The egg products used for these foods are typically formed into a relatively flat and circular shape that generally matches the size and shape of the breakfast sandwich in which they will be positioned.

In one typical method used to make these egg patties, a liquid egg filling that includes liquid egg, flavorings, starches, gums, preservatives, and/or other ingredients is mixed until a desired consistency is reached, and then the liquid egg filling is deposited into a circular recess in a pan. Once the egg product is cooked, the egg patty is removed from the pan and frozen or otherwise processed so that it can later be incorporated into a convenience food. These egg patties will commonly have a relatively planar bottom surface that matches the shape of the pan into which the liquid egg filling is poured. In addition, because the viscosity of the liquid egg filling often allows it to be distributed to an even thickness within pan recesses, the resultant egg patty will also have relatively planar top surface.

While consumers are generally aware that their food products include at least one pre-cooked component, it may be appealing to provide an egg product that is more similar to a freshly-cooked egg product in both its appearance and its texture. Thus, it is desirable to produce a pre-cooked egg product that has both an outer perimeter shape that appears irregular and a top or bottom surface that is “puffed” or otherwise textured to resemble a freshly-cooked egg product.

### SUMMARY

In one aspect of this invention, a method is described for producing individual cooked egg products. The method includes the steps of providing a pan to a liquid egg station, wherein the pan includes at least one pocket with a bottom wall from which a perimeter side wall extends generally upwardly and inwardly, and wherein the bottom wall comprises a planar portion from which a depressed portion downwardly extends. The method further includes depositing a volume of a liquid egg product into at least one of the pockets at the liquid egg station, cooking the deposited volume of liquid egg product with a combination of heat and moisture at a cooking station, and removing the cooked egg product from the pocket. The step of removing the cooked egg product from the pocket may include providing a moving belt onto which each cooked egg product will fall to be conveyed to a cooling area.

In these described methods, a portion of the cooked egg product in contact with the bottom wall may include a bottom surface of the cooked egg product, with a top surface of the cooked egg product being opposite the bottom surface. In such an embodiment, the top surface of the cooked egg product becomes irregular during cooking in the cooking station. In an embodiment, cooking the egg product causes the egg product to shrink inwardly from the perimeter side wall such that the product is easier to release before transferring to the conveyor.

In pans used with the methods described herein, at least one of the pockets includes a perimeter opening having an irregular shape, and/or the percentage of an area of the bottom wall that comprises the depressed portion is in the range of approximately 30 percent to approximately 70 percent of the area of the bottom wall. It is further contemplated that the side walls of the pockets can include at least a portion that is curved and/or at least a portion that is straight.

In another aspect of the invention, a method is described for producing individual cooked egg products. The method includes the steps of providing a pan to a liquid egg station, wherein the pan comprises at least one pocket with a top opening having an outer perimeter shape, a bottom wall with a planar portion from which a depressed portion downwardly extends, and a side wall extending between the top opening and the bottom wall, wherein the side wall is contoured along its height to provide at least one area with a perimeter that is larger than the outer perimeter shape of the top opening. The method further includes depositing a volume of a liquid egg product into at least one of the pockets at the liquid egg station, cooking the deposited volume of liquid egg product with a combination of heat and moisture at a cooking station, and removing the cooked egg product from the pocket.

### BRIEF DESCRIPTION OF THE DRAWINGS

The present invention will be further described with reference to the appended Figures, wherein like structure is referred to by like numerals throughout the several views, and wherein;

FIG. 1 is a photograph of an exemplary cooked egg product or patty of the type that is made in accordance with methods and apparatuses described herein;

FIG. 2 is a schematic side view of an embodiment of an egg product processing and cooking system;

FIGS. 3a-3c are a top view, a front view, and a side view, respectively, of an embodiment of a pan with individual pockets for use in an egg product cooking and processing system of the type illustrated in FIG. 2;

FIGS. 4a-4c are enlarged versions of a portion of the pan of FIGS. 3a-3c, and include a top view, a front view, and a side view, respectively, of a portion a single pocket of the pan;

FIGS. 5a and 5b are a top view and a front view, respectively, of an embodiment of a pan with individual egg pockets for use in an egg product cooking and processing system of the type illustrated in FIG. 2; and

FIGS. 6a and 6b are a top view and a front view, respectively, of an embodiment of a pan with individual egg pockets for use in an egg product cooking and processing system of the type illustrated in FIG. 2.

### DETAILED DESCRIPTION

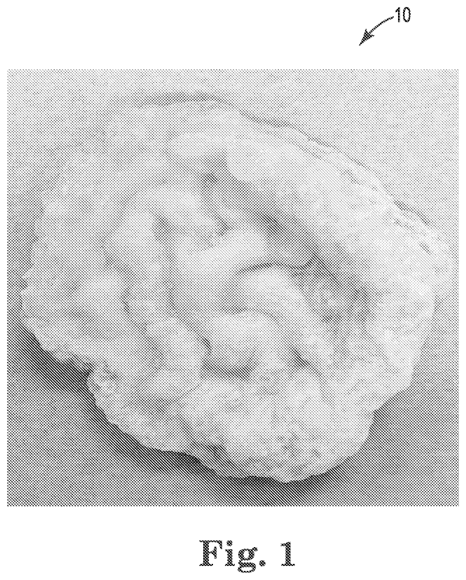

Referring now to the Figures, wherein the components are labeled with like numerals throughout the several Figures, and initially to FIG. 1, a photograph of a cooked egg product or patty 10 illustrates an exemplary end product made by the methods and apparatuses described herein. As shown, the cooked egg product 10 has an irregular perimeter shape and a contoured top surface that together provides a natural or fresh-cooked appearance and texture to a consumer.

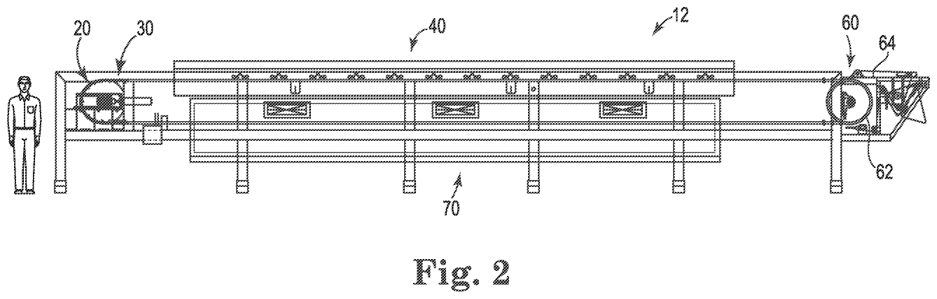

FIG. 2 illustrates an exemplary embodiment of an individual egg product cooking and processing system 12 that generally includes a pan treatment station or area 20, a liquid egg deposit area 30, a cooking station 40, a de-panning or cooked egg removal area 60, and a pan pre-heating area 70. These stations are designed and arranged for cooking multiple formed egg products or patties and moving these products through several processing steps to provide individual egg products that can be frozen or otherwise processed and/or packed for shipment to customers.

The general steps of an exemplary process start with providing one or more pans with openings or pockets configured to accept a liquid food product, such as a liquid egg mixture. Although the pans will be described in more detail below, the pockets are generally provided with an irregular-shaped outer perimeter that simulates the appearance of an egg that spreads out as it is cooked on a relatively flat cooking surface, such as a grill or pan. The pans will generally be preheated prior to accepting any liquid egg product, such as in the pan pre-heating area 70, and are moved along a conveyor until they reach the pan treatment station or area 20. Oil or another non-stick material can be sprayed or otherwise applied to the pans, and particularly within pockets of the pans, as they move through this station 20. Prior to the egg being deposited, the pan can be preheated to a temperature in the range of approximately 240 to 280 degrees F. At least a portion of each of the pans can additionally or alternatively include a non-stick coating such as the material commercially available under the trade designation “Teflon,” for example. That is, whether or not the pan itself includes a non-stick coating, the use of a non-stick spray can optionally be used. The pans are then conveyed toward the liquid egg deposit area 30, where a desired volume of liquid egg product will be deposited into each of the openings or pockets.

Liquid egg products of the general type that can be deposited into embodiments of the pans described herein are well known in the food industry, and can be made by cracking whole eggs, separating the yolk and the albumin, and recombining the yolk and the albumin components to create a component of a final egg mixture. The yolk and/or albumin of the yolk/albumin combination can be replaced or partially replaced by another product to achieve certain nutritional results. For example, the yolk may be replaced with a food product that has a substantially reduced cholesterol content while maintaining the taste and consistency of yolk. The liquid egg product can also be modified by the addition of one or more other ingredients, and in an example, can be a mixture including whole eggs, whey, modified corn starch, salt, carob bean/guar gum blend, and citric acid, for example. In one exemplary embodiment, between around 2 ounces and 2½ ounces of such an egg mixture is deposited into each of the openings or pockets at this liquid egg deposit area 30. However, the volume of egg mixture deposited will depend on the pan size and desired final product and can include any desired volume of a liquid egg product.

The pans with pockets holding the liquid egg product are then conveyed to the cooking station or area 40. The oven temperature and the time that each pocket spends in the cooking station 40 can be adjusted to optimize the desired amount of cooking. In this cooking station 40, the heated area through which the pans travel provides sufficient heat and moisture to cook the egg product. In an embodiment, the temperature of this area is in the range of approximately 240 to 280 degrees, for example. In an embodiment, the time that the egg product spends in this cooking station 40 is in the range of 2 minutes to 2 minutes, 30 seconds, although the time can be longer or shorter than this range, depending on the amount of liquid egg product contained in the openings or pockets, the oven temperature, the desired amount of cooking, and the like. The relative humidity within the oven may be adjusted dependent on the local environmental conditions as identified within the examples provided herein. This cooking step for the product tends to slightly shrink the cooked egg product such that it will release more easily from the pan.

The pans are then conveyed to the de-panning or cooked egg removal area 60. As shown, the egg removal area 60 includes a curved conveyor section 62 and a moving belt 64. As the pans follow the curve of the curved conveyor section 62, the cooked egg products fall from the pockets and onto the moving belt 64. The speed of the curved conveyor section 62 and the moving belt 64 are synchronized in such a way that the cooked egg products that fall onto the belt 64 are moved away from the conveyor section 62 prior to release of subsequent cooked egg products from their respective pans. The moving belt 64 then moves the cooked egg products away from the cooking and processing system 10 and to an area in which the products can be frozen and/or packaged.

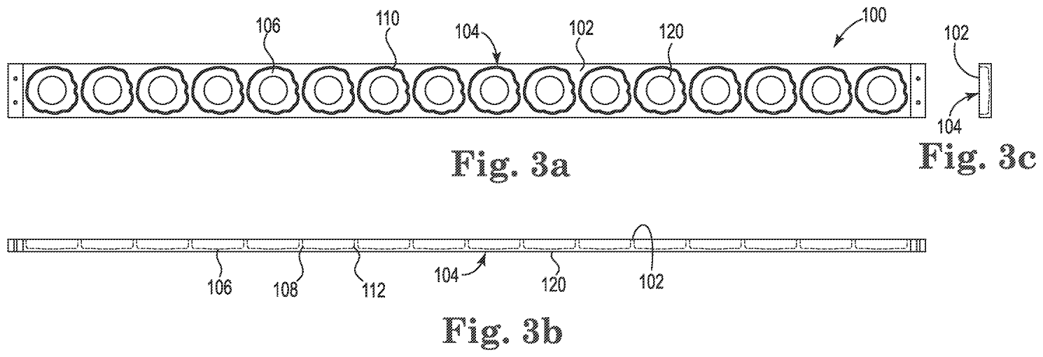

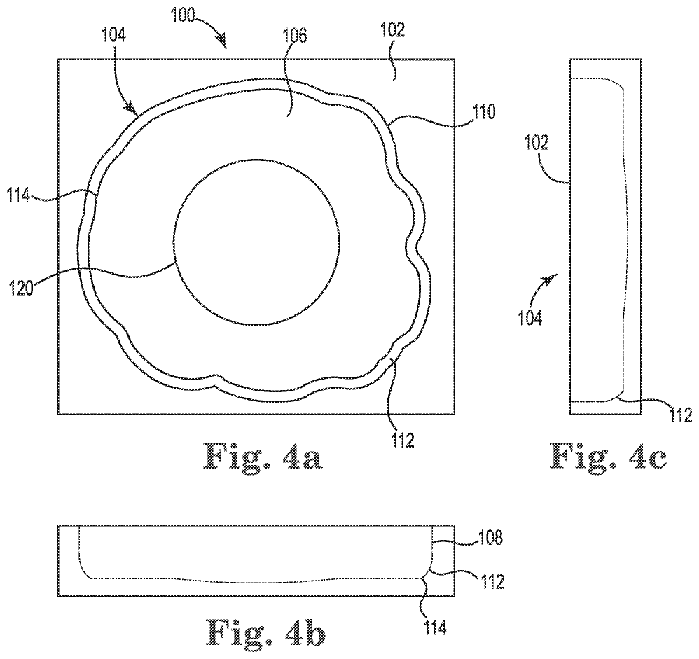

Referring now to FIGS. 3a-3c, a top view, a front view, and a side view, respectively, of an exemplary pan 100 are illustrated. The pan 100 is used for the cooking of liquid egg products an individual egg product cooking and processing system of the type described above relative to FIG. 2. FIGS. 4a-4c are enlarged versions of a portion of the pan of FIGS. 3a-3c, and include a top view, a front view, and a side view, respectively, of a single pocket of a multi-pocket pan.

As shown, pan 100 includes a top planar surface 102 from which sixteen pockets 104 extend downwardly in a single row. Such an arrangement is intended to be exemplary, as it is understood that a wide variety of pocket quantities and arrangements are contemplated herein. For example, a pan may be provided with more or less than sixteen pockets, a pan may have more than one row of pockets, a pan may have pockets arranged in a configuration that is different than a single row, and/or a pan may include other single or multi-pocket configurations. In addition, while FIG. 3a shows identical pockets 104 along the length of the pan 100, it is possible that at least some of the pockets 104 of a particular pan have a different configuration than other pockets 104 of the same pan.

The material from which the pan 100 is made can be generally rigid, and a plurality of similar or identical pans is operatively attached to a chain or other device in a conveyor arrangement. The number and size of the pans for a particular conveyor are designed to accommodate the parameters of the production line in which the pans are being conveyed, such as the conveyor arrangement shown in FIG. 2, for example. However, the system in which the pans are used does not necessarily include such a conveyor, but can instead include pans that are moved through a differently configured egg product cooking and processing system in another manner. In an embodiment, at least a portion of the pans can made of a material that is at least slightly flexible.

Each of the pockets 104 generally includes a bottom wall 106 from which a perimeter side wall 108 extends generally upwardly, terminating at the top planar surface 102. The top of the pocket 104 is defined by a peripheral top opening 110, which is shown as being generally circular but with irregular contours that simulate the outer shape of a freshly cooked egg patty. As shown, a number of convex protuberances are adjacent to concave portions and other curved sections around the peripheral top opening 110. The illustrated shape can be somewhat or considerably different from shown, with more or less protuberances, concave portions, and/or other curved sections around the peripheral top opening 110. The perimeter side wall 108 is generally perpendicular to the bottom wall 106, although it can be angled to slope at least slightly inwardly or outwardly toward the peripheral top opening 110 of the pocket 104. Further, each of the pockets 104 of a particular pan 100 may have the same or different perimeter shape than other pockets 104 of the same pan 100.

An area 112 at which the perimeter side wall 108 and the bottom wall 106 intersect can include a curved transition between the two walls, as shown, or can be more of a sharp corner. In some cases, providing at least a slight curve or contour to this area allows for the egg products to release more easily from the pockets 104 after cooking, but such a curved area is not required. The area 112 is shown to have a shape that matches that of the peripheral top opening 110, with a defining line 114 at the point where it meets the bottom wall 106.

The pockets 104 also include a depressed or concave portion 120 that extends downwardly from the generally planar bottom wall 106 in the same direction that the pocket 104 extends from the top planar surface 102 of pan 100. The depressed portion 120 can be generally centrally positioned within the pocket 104 on the bottom wall 106, although it can instead be offset at least slightly from the center of the pocket 104. In an exemplary embodiment, the depressed portion 120 is generally circular, although it may instead have a different shape. One embodiment of the depressed portion 120 is generally symmetric about a line drawn through its center in any direction, or can instead be irregular in shape such that it does not have such a line of symmetry. In embodiments of the pockets 104 used in the processes described herein, the area of the depressed portion of each of the pockets is in the range of between 30 percent and 70 percent of the area of the bottom wall 106; however, it is contemplated that the depressed area is less than 30 percent or greater than 70 percent of the area of the bottom wall 106.

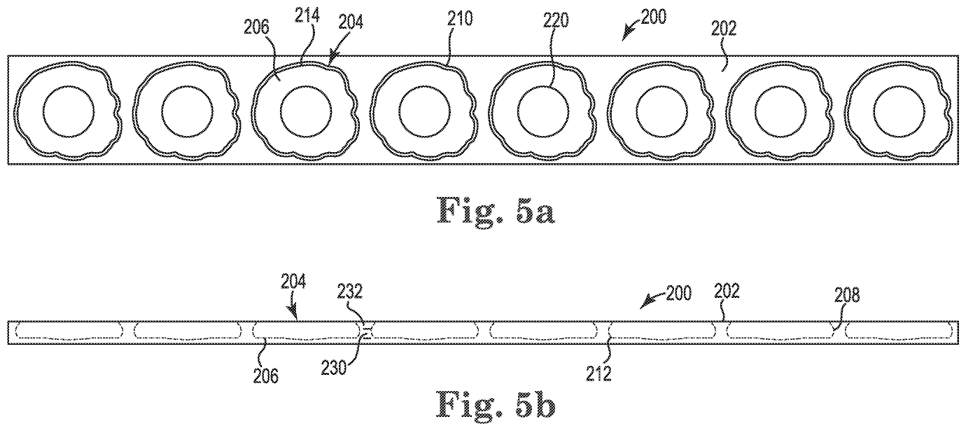

Referring now to FIGS. 5a and 5b, a top view and a front view, respectively, of an exemplary pan 200 are illustrated, which pan 200 is used for the cooking of liquid egg products in an individual egg product cooking and processing system of the type described above relative to FIG. 2. As shown, pan 200 includes a top planar surface 202 from which eight pockets 204 extend downwardly in a single row. Such an arrangement is intended to be exemplary, as it is understood that a wide variety of pocket arrangements are contemplated herein. While FIGS. 5a and 5b show identical pockets 204 along the length of the pan 200, it is possible that at least some of the pockets 204 of a particular pan have a different configuration than other pockets 204 of the same pan.

The pockets 204 generally include a bottom wall 206 from which a perimeter side wall 208 extends generally upwardly, terminating at the top planar surface 202. The top of the pocket 204 is defined by a peripheral top opening 210, which is shown as being generally circular but with irregular contours that simulate the outer shape of a freshly cooked egg patty. As shown, a number of convex protuberances are adjacent to concave portions and other curved sections around the peripheral top opening 210. The illustrated shape can be somewhat or considerably different from shown, with more or less protuberances, concave portions, and/or other curved sections around the peripheral top opening 210.

The perimeter side wall 208 includes at least one convex portion 230 that extends or “bulges” outwardly as compared to a wall that would be perpendicular to the bottom wall 206. Between the convex portion 230 and the top opening 210 of the pocket 204 is an inwardly angled portion 232 that extends generally inwardly toward the top opening 210. With such an embodiment, the top opening 210 can have an outer periphery that is smaller than, larger than, or the same size as the periphery of the bottom wall 206.

An area 212 where the perimeter side wall 208 and the bottom wall 206 intersect can include a curved transition between the two walls or can be more of a sharp corner. In some cases, providing at least a slight curve or contour to this area allows for the egg products to release more easily from the pockets 204 after cooking, but such a curved portion is not required.

The pockets 204 also include a depressed or concave portion 220 that extends downwardly from the generally planar bottom wall 206 in the same direction that the pocket 204 extends from the top planar surface 202 of pan 200. The depressed portion 220 can be generally centrally positioned within the pocket 204 on the bottom wall 206, although it can instead be offset at least slightly from the center of the pocket 204. In an exemplary embodiment, the depressed portion 220 is generally circular, although it may instead have a different shape. One embodiment of the depressed portion 220 is generally symmetric about a line drawn through its center in any direction, or can instead be irregular in shape such that it does not have such a line of symmetry. In embodiments of the pockets 204 used in the processes described herein, the area of the depressed portion of each of the pockets is in the range of between 30 percent and 70 percent of the area of the bottom wall 206; however, it is contemplated that the depressed area is less than 30 percent or greater than 70 percent of the area of the bottom wall 206.

In one specific example, a pan is approximately 5 inches wide, and a representative pocket is approximately 4.55 inches wide and approximately 4.97 inches long. The depth of the pocket is approximately 0.75 inches deep, as measured from the bottom wall of the pocket to the top planar surface of the pan. The depressed portion is approximately 2.33 inches in diameter, and approximately 0.06 inches deep.

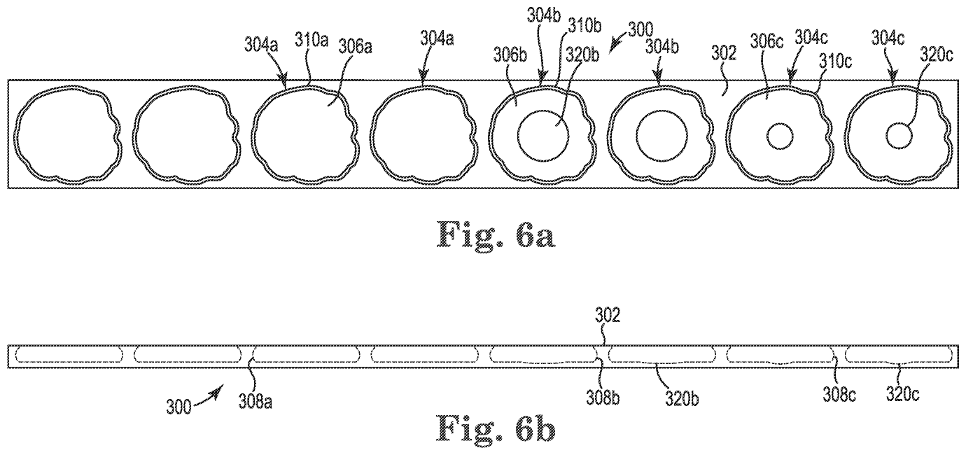

Referring now to FIGS. 6a and 6b, a top view and a front view of an exemplary pan 300 are illustrated, which pan 300 is used for the cooking of liquid egg products in an individual egg product cooking and processing system of the type described above relative to FIG. 2. As shown, pan 300 includes a top planar surface 302 from which three different configurations of pockets 304a, 304b, and 304c extend downwardly in a single row. Such an arrangement is intended to be exemplary, as it is understood that a wide variety of pocket arrangements are contemplated herein. This arrangement of different pockets along the length of the pan represents just one of many possible arrangements of pockets along a length of a pan used in methods described herein.

The pockets 304a, 304b, and 304c each generally include a bottom wall 306a, 306b, 306c, respectively, from which a perimeter side wall 308a, 308b, and 308c, respectively, extends generally upwardly, terminating at the top planar surface 302. The top of the pockets 304a, 304b, and 304c are each defined by a peripheral top opening 310a, 310b, and 310c, respectively, which is shown as being generally circular but with irregular contours that simulate the outer shape of a freshly cooked egg patty. As shown, a number of convex protuberances are adjacent to concave portions and other curved sections around the peripheral top openings. The illustrated shape can be somewhat or considerably different from shown, with more or less protuberances, concave portions, and/or other curved sections around the peripheral top openings 310a, 310b, and 310c.

The perimeter side walls 308a, 308b, and 308c each include at least one convex portion (which can be similar to convex portions 208 of FIG. 5b) that extends or “bulges” outwardly as compared to a wall that would be perpendicular to the bottom wall of the respective pocket. Between the convex portion and the top openings 310a, 310b, and 310c of the pockets 304a, 304, and 304c, respectively, is an inwardly angled portion that extends generally inwardly toward the top pocket openings. With such an embodiment, the top opening 310a, 310b, and 310c, respectively, can have an outer periphery that is smaller than, larger than, or the same size as the periphery of the bottom wall 306a, 306b, and 306c, respectively.

In this arrangement with three different configurations of pockets, the pockets 304a do not include a depressed portion extending downwardly from its bottom wall 306a as is included in other embodiments described herein, the pockets 304b are similar to those illustrated in FIGS. 5a and 5b and include a depressed portion 320b that extends downwardly from the bottom wall 306b, and the pockets 304c include a depressed portion 320c that is substantially smaller than the depressed portion 320b of pocket 304b. The depressed portion 320c can be generally centrally positioned within the pocket 304c on the bottom wall 306c, although it can instead be offset from the center of the pocket 304c. In an exemplary embodiment, the depressed portion 320c is generally circular, although it may instead have a different shape. One embodiment of the depressed portion 320c can be generally symmetric about a line drawn through its center in any direction, or can be irregular in shape such that it does not have such a line of symmetry.

Referring again to FIG. 2, during cooking at the cooking station 40 using any of the pans with pockets described above, the liquid egg product tends to “puff” or rise upwardly in an irregular manner, which provides a “scrambled” or “natural” appearance to the top surface of the final product. This formation of the top surface of the egg product is caused by a combination of heat and moisture, along with the use of the depressed portion of the pocket. Because the top of the egg products are allowed to rise and deform naturally without constraints, the top surface of each of the cooked egg products will be at least slightly different from each other. In contrast, the bottom surface of each of the cooked egg products will be nearly the same as each other because the bottom surface is constrained by the bottom wall of the pan.

The combination cooking process that includes both heat and moisture also tends to shrink the product slightly in diameter such that it is more easily removable from the pocket after cooking. This shrinking of the egg product generally will occur after the egg product is moved through the cooking station, where the product tends to “inflate” or “puff up” during the final cooking time and then tends to “collapse” once removed from the cooking station. This shrinking of the product also tends to make its removal from the pan easier.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of producing individual cooked egg products, comprising the steps of:
providing a pan to a liquid egg station, wherein the pan comprises at least one pocket that comprises a bottom wall from which a perimeter side wall extends generally upwardly and inwardly, and wherein the bottom wall comprises a planar portion from which a depressed portion downwardly extends;
depositing a volume of a liquid egg product into the at least one pocket at the liquid egg station;
cooking the deposited volume of liquid egg product with a combination of heat and moisture at a cooking station; and
removing the cooked egg product from the at least one pocket.

2. The method of claim 1, wherein a portion of the cooked egg product in contact with the bottom wall comprises a bottom surface of the cooked egg product, and wherein a top surface of the cooked egg product is opposite the bottom surface.

3. The method of claim 1, wherein the top surface of the cooked egg product becomes irregular during cooking at the cooking station.

4. The method of claim 1, wherein the top surface of the cooked egg product becomes irregular when the combination of heat and moisture are provided at the cooking station.

5. The method of claim 1, wherein the step of cooking the egg product at the cooking station further comprises providing sufficient relative humidity to cause the egg product to shrink inwardly from the perimeter side wall.

6. The method of any of claim 1, wherein the at least one pocket comprises a perimeter opening having an irregular shape.

7. The method of any of claim 1, wherein the percentage of an area of the bottom wall that comprises the depressed portion is in the range of approximately 30 percent to approximately 70 percent of the area of the bottom wall.

8. The method of claim 1, further comprising a step of preheating the pan prior to depositing the liquid egg product into at least one of the pockets.

9. The method of claim 1, further comprising a step of pre-treating the at least one pocket with a non-stick material prior to the step of depositing the liquid egg product into at least one of the pockets.

10. The method of claim 1, further comprising a step of conveying the deposited liquid egg product from the liquid egg station to the cooking station.

11. The method of claim 1, wherein the step of removing the cooked egg product from the pocket comprises providing a moving belt onto which each cooked egg product will fall for conveyance to a cooling area.

12. The method of claim 1, wherein the side wall of each of the pockets comprises at least a portion that is curved.

13. The method of claim 1, wherein the side wall of each of the pockets comprises at least a portion that is straight.

14. The method of claim 1, wherein the at least one pocket comprises a plurality of pockets.

15. The method of claim 1, wherein the cooking station comprises an enclosure to which heat and moisture are provided to surround at least a portion of the pan containing the egg product.

16. A method of producing individual cooked egg products, comprising the steps of:
providing a pan to a liquid egg station, wherein the pan comprises at least one pocket that comprises:
a top opening having an outer perimeter shape;
a bottom wall that comprises a planar portion from which a depressed portion downwardly extends; and
a side wall extending between the top opening and the bottom wall, wherein the side wall is contoured along its height to provide at least one area with a perimeter that is larger than the outer perimeter shape of the top opening;
depositing a volume of a liquid egg product into the at least one pocket at the liquid egg station;
cooking the deposited volume of liquid egg product with a combination of heat and moisture at a cooking station; and
removing the cooked egg product from the at least one pocket.

17. The method of claim 16, wherein the side wall of at least one of the pockets comprises a convex portion.
